(19) United States
(12) Patent Application Publication
(10) Pub. No.: US 2013/0017529 A1
(43) Pub. Date: Jan. 17, 2013

(54) METHOD AND APPARATUS FOR GENERATING EDUCATIONAL CONTENT

(71) Applicants: Chris Nguyen, Baltimore, MD (US); Chris Hoehn-Saric, Miami, FL (US); Lee Clinton, Baltimore, MD (US)

(72) Inventors: Chris Nguyen, Baltimore, MD (US); Chris Hoehn-Saric, Miami, FL (US); Lee Clinton, Baltimore, MD (US)

(73) Assignee: LEARNING CENTER OF THE FUTURE, INC., Baltimore, MD (US)

(21) Appl. No.: 13/180,095

(22) Filed: Jul. 11, 2011

(51) Int. Cl. G09B 7/00

(52) U.S. Cl. 434/362

(57) ABSTRACT

A learning system includes at least one student workstation which holds a learning session for a student. The system generates and displays primary instructional material to the student in accordance with student profile data for the student. The system causes supplemental material or content to be generated and displayed to the student at the student workstation when a downtime interval is triggered. The system generates the supplemental material in accordance with the student profile data for the student. The disclosed system thus enables downtime to be more appropriately utilized by the student, in a manner that accommodates the learning preferences and skill gaps of the student and/or that rewards the student for showing proficiency at a skill.

### BACKGROUND

It is known that students can benefit from receiving more individualized attention from their teachers. Individualized learning environments enable teachers to closely connect with students and understand how each student learns. When teachers spend more time getting to know a student and his or her learning style and capabilities, they are better able to tailor teaching approaches and actively engage that student. As a result, this enables the student to achieve greater academic and personal success.

However, even in learning environments where the student-to-teacher ratio is low, it is sometimes the case that a teacher is not immediately available to assist a student while that student is working on an educational task (e.g., an assignment or lesson). For example, when a student completes an assignment or if the student has a question about an assignment, the student may have wait for the teacher to become available before the student can move on. During this downtime, students may become distracted or may lose focus on the task at hand.

It is also known that one of the best ways for students to retain information or improve their skills is through repetition. Practicing a skill again and again reinforces the information and helps students to become proficient at the skill. Some students may require more practice than others, and a teacher may not always be available to help these students. On the other hand, students who have demonstrated proficiency in a skill may quickly become bored with simply doing additional exercises in that same subject area.

What is therefore needed in view of the above is a system and method for providing tailored supplemental content to students during downtime or transition periods to help them stay focused and engaged.

### SUMMARY

The system disclosed herein enables managing the activities of one or more students during downtime periods or intervals, such as the transition time between lessons. More particularly, the disclosed system enables each student to interact with supplemental material specifically selected for that student during downtime intervals, in a manner that accommodates the learning preferences and skill gaps of the student and/or that rewards the student for showing proficiency at a skill.

In one embodiment, the system includes at least one student computer or student workstation configured to hold a learning session for a student. Primary instructional material or content (e.g., one or more educational assignments or lessons to be completed by the student during the learning session) is generated and delivered to the student workstation. The primary instructional material is generated for a particular student based on a student profile associated with that student. The student profile may include personal information (e.g., name, gender, birthday, interests, etc.) and may specify at least one learning objective and/or skill gap associated with the student. As further discussed below, the student profile is utilized to create a learning prescription (e.g., a compilation or list of instructional or other materials) for the student. The primary instructional material for the student is generated in accordance with the student's learning prescription.

The system causes the generated primary instructional material to be delivered to the student such as by causing the primary instructional material to be displayed to the student on a display device of the student computer or student workstation. The system enables the student to interact with the displayed primary instructional content at the student workstation. For example, the system displays a math lesson including a plurality of problems to be completed by the student. The system enables the student to input answers to the problems at the student workstation.

As the student progresses through the displayed primary instructional material, the system tracks various activities and inputs made by the student (e.g., the student's responses to the problems) and records or collects student input data. The student profile is updated based on the student input data.

As the system monitors the student's activities or progress on the displayed primary instructional material, the system determines whether a designated triggering event occurs at the student workstation. The designated triggering event triggers or initiates a downtime period or interval (e.g., a period during which the student is not interacting with the primary instructional material). Upon detecting that the designated triggering event occurs, the system retrieves or selects supplemental material to be displayed to the student during the downtime interval. The system switches from displaying the primary instructional material to displaying the selected supplemental material and enables the student to interact with the supplemental material during the downtime interval.

The designated triggering event may occur when the system detects that: (i) the student has completed a lesson; (ii) the student has completed a designated portion of a lesson (e.g., a designated number of problems of the lesson); (iii) the student has completed a learning session; (iv) the student has completed a designated portion of a learning session; (v) a designated amount of time has elapsed (e.g., the lesson and/or learning session has timed out); or (vi) any other suitable event which triggers a period of student inactivity (or an idle state) at the student workstation occurs. In one embodiment, the system automatically switches or moves to the supplemental material upon detecting that the designated triggering event has occurred (e.g., when the downtime interval is triggered). In certain embodiments, the system switches or moves to the supplemental material based at least in part on activities occurring at other student workstations. For example, if the system detects that a first student at a first student workstation has completed a lesson, and the teacher is busy working with another student at another student workstation, the system automatically provides supplemental material to the first student. In this manner, the present disclosure enables downtime to be more effectively utilized by the student.

In one embodiment, the system retrieves or selects the supplemental material to be displayed to a particular student during downtime based on the student profile associated with that student (e.g., the student's prescription or the student's performance on previous educational tasks, such as the previous lesson). The supplemental material selected for display to the student may be related to the primary instructional content. For example, if the student is working on a math lesson including a set of math problems when the designated triggering event occurs, the system provides an additional set of math problems for the student to complete during the downtime interval. The supplemental material may include enjoyable content, such as a fun game or activity which is not necessarily educational or which is not necessarily related to the primary instructional material. The supplemental material may include a bonus round, which is provided as a reward for demonstrating mastery of a skill. The bonus round may include a fun game or activity. Alternatively, the bonus round may include an educational activity, which provides one or more opportunities for the student to earn one or more rewards. For example, the bonus round may include a set of educational problems, and the student has the opportunity to earn redeemable tokens by achieving certain performance-based criteria in connection with the set of problems.

In one embodiment, the supplemental material selected and displayed to the student during downtime is based on the student achieving a certain score on one or more lessons (e.g., the lesson immediately preceding the downtime or a group of previous lessons. For example, if the student scores 80% or better on a lesson, the system provides the student with a game or a bonus round to the student during the downtime. If the student does not get a score of 80% or better on the lesson, the system provides additional practice problems (e.g., additional problems covering the same skill that was covered in the lesson) during downtime instead of a game or bonus round.

In one embodiment, the supplemental material selected and displayed to the student is based on the student completing a lesson within a specified amount of time. For example, if the student does not complete a lesson within a specified amount of time, the system provides an educational activity (e.g., additional problems) during downtime. However, if the student completes the lesson within the specified amount of time, the system enables the student to play a game or participate in a bonus round during downtime. This encourages students to complete lessons quickly and efficiently.

In certain embodiments the system enables students to create their own supplemental material during downtime intervals. For example, the system enables a student to create double digit addition problems and work through those problems during the downtime interval. The supplemental material created by the student may be scored or corrected by the computer or by the teacher. In one embodiment, the system automatically determines the answers to the supplemental material (e.g., problems) created by the student, such that a teacher can easily correct the work without re-working the problem.

The student-generated supplemental material may be stored and re-used throughout the system. For example, supplemental material generated by a first student may be stored and subsequently displayed to a second student when that student has downtime. Alternatively or additionally, student-generated supplemental material may be incorporated into instructional materials, which are provided to students during their learning sessions. Students may be rewarded, such as with redeemable tokens or other suitable awards or prizes, for creating supplemental material.

The disclosed system thus enables student downtime to be more appropriately and effectively utilized by students. The disclosed system rewards students who show that they are advancing at a good pace and gives students who are not showing the same advancement the opportunity to continue working on developing their skills.

Additional features and advantages are described herein, and will be apparent from, the following Detailed Description and the figures.

### BRIEF DESCRIPTION OF THE FIGURES

FIG. 1 is a block diagram showing one example of a network communications system for implementing the system disclosed herein.

FIG. 2 is a more detailed block diagram showing one example of a computing device.

FIG. 3A is a schematic diagram of one example embodiment of the system of the present disclosure, which is designed for use with a worktable that seats a teacher and a number of students.

FIG. 3B is a FIG. 2 is a schematic diagram of another example embodiment of the system of the present disclosure, which includes a plurality of worktables, such as the worktable of FIG. 3A.

FIG. 4 is a flowchart of an example process for managing student activities.

FIGS. 5 to 15 are screen shots of a display device of a first student workstation in one example of the system disclosed herein.

### DETAILED DESCRIPTION

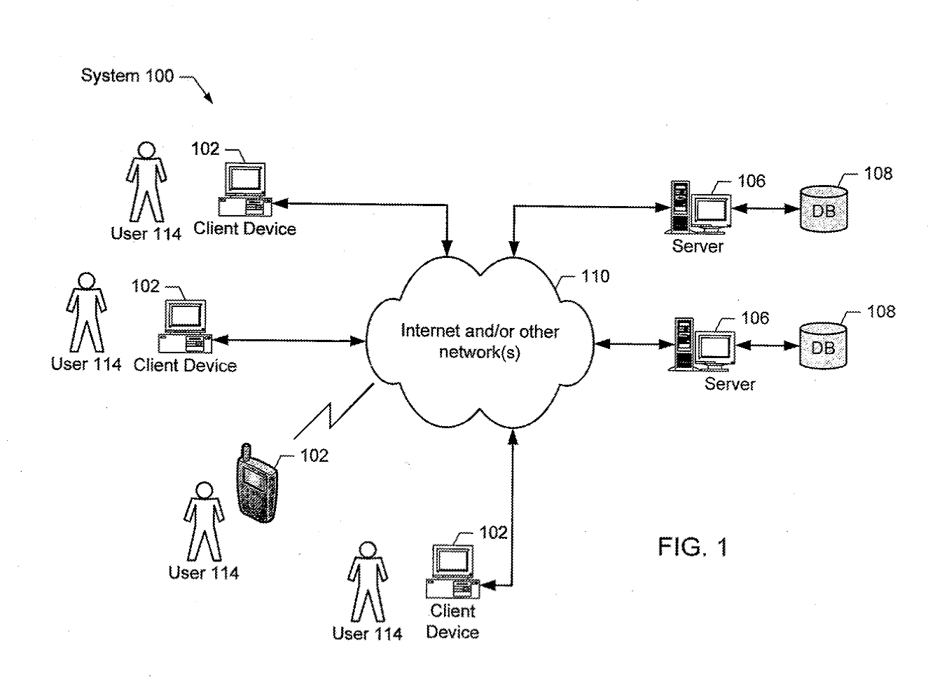

The present disclosure provides a computer based system for managing the activities of at least one student engaged in one or more learning sessions provided to a student workstation for the student. Referring now to FIG. 1, the disclosed system may be realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The databases 108 may be connected directly to the web server 106 and/or via one or more network connections.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

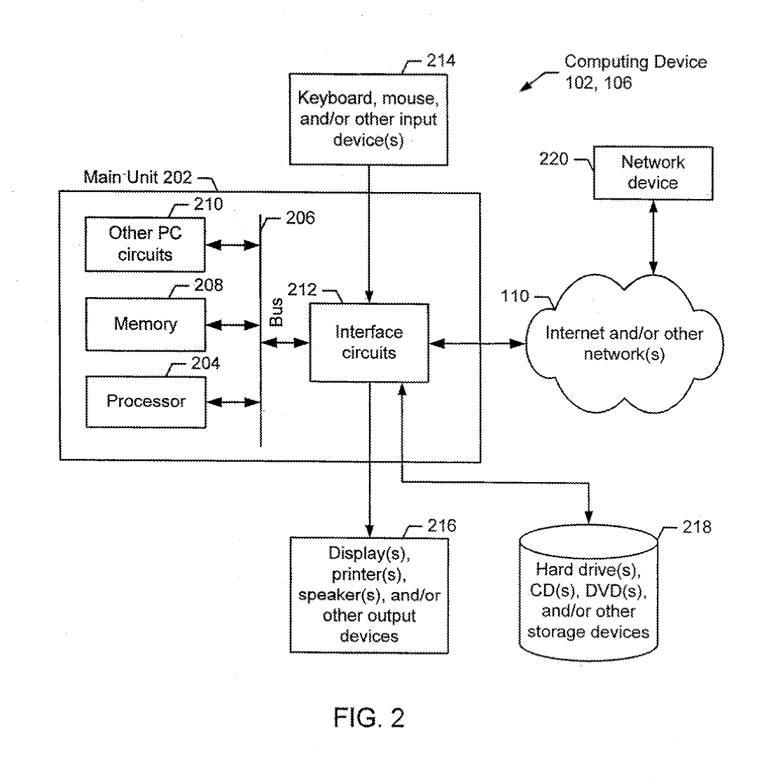

A more detailed block diagram of the electrical systems of a computing device (e.g., client device 102 and/or server 106) is illustrated in FIG. 2. Although the electrical systems of a client device 102 and a typical server 106 may be similar, the structural differences between the two types of devices are well known.

The client device 102 may include a personal computer (PC), a tablet-style computer, a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc. Stylus-sensitive displays are currently available for use with tablet computers, and such displays may be used as device 216, as discussed below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data or content used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

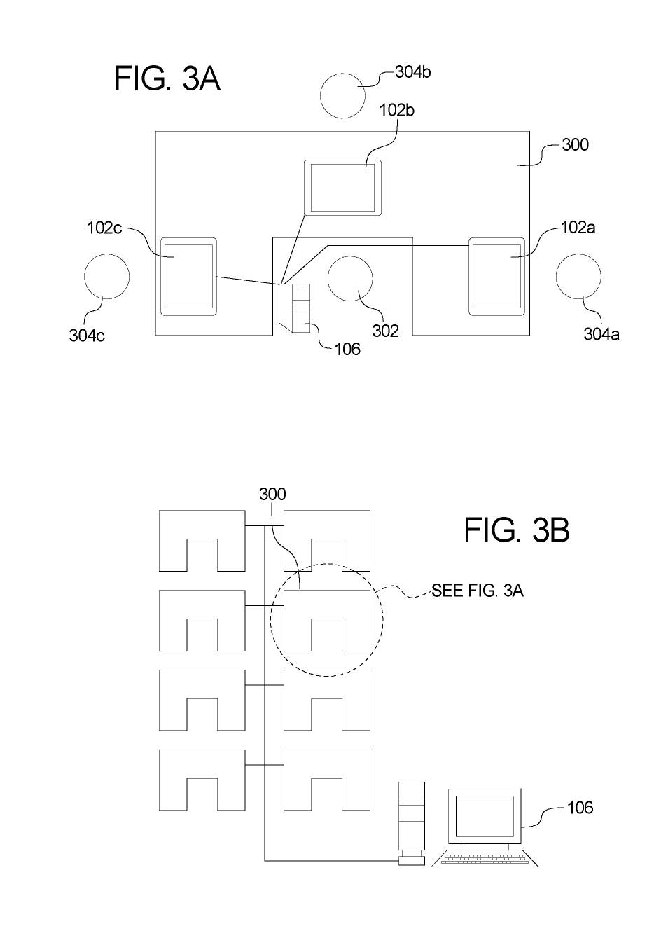

In one example, as shown schematically in FIG. 3A, the system is designed for use with a worktable 300 that seats a teacher and a plurality of students. The teacher instructs one or more students at the worktable 300. The worktable 300 has a teacher position 302 where a teacher can be seated and a plurality of student positions 304a, 304b, and 304c where students can be seated. FIG. 3A shows three student positions 304a, 304b, and 304c at the worktable 300, but any number of student positions is possible depending on the desired student/teacher ratio.

The teacher sits at the worktable 300, and each student sits at the worktable 300 at a location that is generally opposite the teacher. A computing device or student workstation 102a, 102b, and 102c (collectively 102) is located between each student and the teacher. In the illustrated example, the student workstations 102 are networked CPUs with a pen-based tablet input and display. Each pen tablet or student workstation 102 is placed on the surface of worktable 300 in front of a respective one of the student positions 304a, 304b, and 304c. In FIG. 3A, the worktable 300 is shown in the shape of a “U” with the teacher position in the middle surrounded by the student positions (and the student workstations located at the student positions). However, it should be appreciated that other suitable configurations for the worktable 300 may be employed.

In the illustrated example, system is designed to preserve student-teacher interaction because the tablet or student workstation 102 is on the surface of the worktable 300 and is not a vertical display interfering with eye contact. Other embodiments are contemplated which further provide mechanisms by which the angle of the screen may be adjusted, or other input devices such as keyboards to supplement the pen input. It should be appreciated that, although the workstations 102 are referred to herein as “student workstations,” at various points or stages during learning sessions, the student and teacher may share the data or material being displayed on the display device of the workstation. That is, multiple users (e.g., the teacher and a student) may share the same single display device of a student workstation, as discussed in detail below.

The system architecture incorporates a server 106 networked to and capable of receiving input from the workstations 102. The server 106 is adapted to track the various activities and inputs of each student at the student workstations 102 and record student input data, either automatically through the student workstations 102, or manually as a result of teacher inputs. FIG. 3B shows another embodiment including a server 106 and multiple worktables 300, such as the worktable illustrated in FIG. 3A.

Each student workstation 102 is capable of running any one of a plurality of programs, either supplied by the network provider or over the server 106, or run from a hard disk, RAM or other storage device on the workstation itself. In other words, for example, the system software and applications software are preferably fully compatible with commercially available computer systems, such as, for example Pentium™ based personal computer systems, to allow third party commercial educational software to be easily integrated over the network. Of course, the present disclosure is not limited to any one kind of processor type, and other computer systems and processors may be employed. In another embodiment, the student workstations are merely displays and inputs, and all calculation takes place at the server level.

Suitable content or material (e.g., primary instructional material and/or supplemental material) may be displayed to each of the students through the pen tablet interface of the student's workstation 102. The delivery of such content or material is accomplished in accordance with a previously assessed student profile associated with each student, as further discussed below. The system may conduct an assessment and diagnosis to generate a student profile.

The system contemplates an arrangement whereby a student enters the learning environment represented in FIGS. 3A and 3B and receives a battery of assessment tests, which, in a preferred system, would be an automated battery of tests for assessment and diagnostics in order to produce the student profile.

The tests are generally designed to identify the ability to perform different tasks or the mastery of certain learning objectives or skills. The assessment tests are scored and analyzed by computer to generate a student profile which is then utilized by the system of the present invention to generate a learning program suited to that student. The student profile contains, among other data, skill gaps which need to be filled by further instruction. Ongoing assessments may be used to expand and update the student profile.

The assessment and diagnostic testing required to generate the student profile is preferably automated in order to avoid manual testing errors that can have significant effect on the assessment of the student's progress. Such automated testing can be executed at the workstation using the pen tablet interface of the preferred embodiment, or another appropriate interface. It is also possible for assessment and diagnostic testing to take place remotely from the worktable.

A number of alternate arrangements of assessment and diagnostic tests for generating a student profile are contemplated. A first arrangement employs a scannable score sheet for machine scoring. The scannable score sheet is scanned by an image scanner. The scannable score sheet is typically a “bubble sheet” for entry of answers. This technique uses an answer sheet which is keyed to an associated instruction booklet. Another alternative arrangement of the assessment and diagnostic test is a computer test arrangement in which the computer screen is used to display test questions and the answers may be entered on the screen using the electronic pen or other input device. Either in the embodiment using scannable sheet or the computer test, scores are computed automatically upon entry into the computer, and a student profile generated from the results.

A student prescription is made or created in accordance with the student profile. In general, the teacher selects instructional material for each student in accordance with the prescription made for that student (e.g., from among the instructional materials assembled in accordance with the student profile).

The teacher can hold multiple learning sessions with the students seated at the worktable. For example, the teacher may cause instructional materials, such as a math lesson including a number of math problems, to be displayed to a first student on the workstation for that student. That first student may then answer the math problems by physically entering the answer on the screen. In the meantime, the teacher may be working with a second student on different instructional materials delivered to the workstation for the second student. When the first student has completed the lesson, the teacher can review the student's work, such as by calling up the correct answers on that student's workstation for comparison with the student's answers. As discussed further below, the teacher may be required to supply certain identifying information to have access to the answers or an answer key. After reviewing the student's work, the teacher may provide feedback to the student. For example, if any answers are incorrect, the teacher may discuss the reason for the error with the student.

A student's performance on the instructional material is evaluated and the results are recorded or stored in the student profile for that student. In this manner, the system can track a student's progress based on instructional materials, skill gaps, teacher, time spent on different skills, etc. Such records may be automatically logged and used in the updating or amendment of the student profile. Some records for use in updating or amending the student profile may also be entered manually by the teacher.

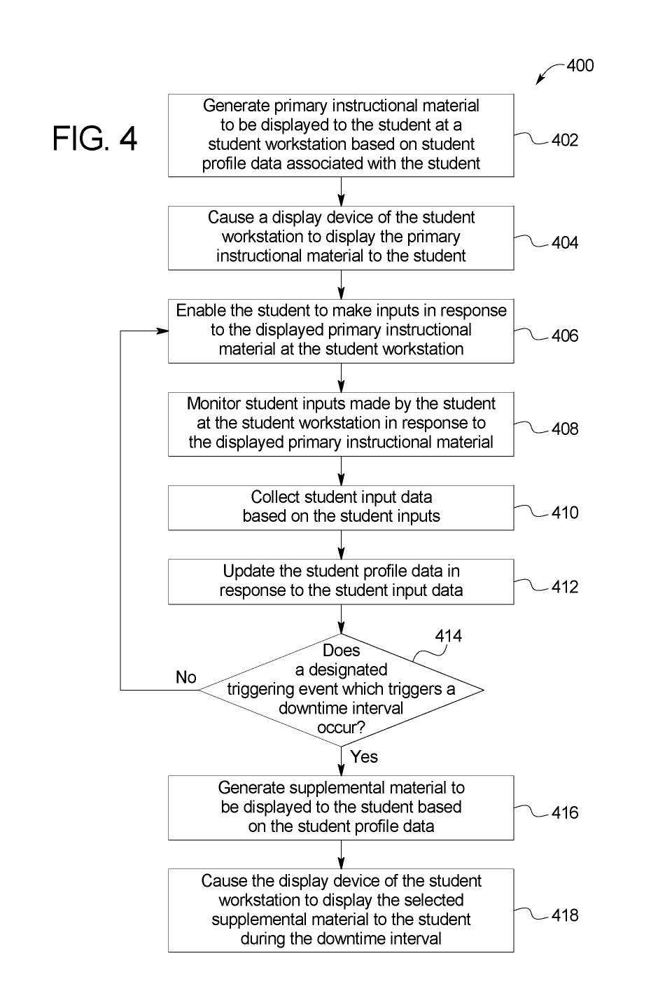

A flowchart of an example process 400 for managing the activities of a student at a networked computing device or student workstation 102 is illustrated in FIG. 4. Preferably, the process 400 is embodied in one or more software programs which is stored in one or more memories and executed by one or more processors. Although the process 400 is described with reference to the flowchart illustrated in FIG. 4, it will be appreciated that many other methods of performing the acts associated with process 400 may be used. For example, the order of many of the steps may be changed, and many of the steps described are optional. The process 400 of FIG. 4 may be executed by a system such as that illustrated in FIGS. 3A and 3B, including a server 106 and one or more computing devices or student workstations 102.

In general, the process 400 causes the system to manage the activities of one or more students engaged in respective learning sessions at the student workstations 102. Individualized primary instructional materials are generated and delivered to each of the students at the student workstations 102. When a downtime interval is triggered at any one of the student workstations 102, the system causes supplemental material to be displayed at that student workstation 102. The system enables the student at that student workstation 102 to interact with the supplemental material until the downtime interval ends. In this manner, the disclosed system enables downtime, such as the transition time between lessons or between learning sessions, to be more appropriately utilized.

The example process 400 of FIG. 4 begins when the system generates primary instructional material or content to be delivered to each of the students based on student profile data associated with that student (block 302). The primary instructional material or content may include instructional software, electronic text books, lessons, work sheets, practice sheets, problem sets, or any other suitable type of content or material for conducting an instructional session. For example, the primary instructional material may include at least one lesson having a plurality of problems to be completed by the student.

The process 400 causes the system to deliver the generated primary instructional material (e.g., a lesson) to each student, such as by displaying the primary instructional material on a display device of the student workstation 102 for that student (block 304). In one embodiment, the system causes the primary instructional material to be delivered to a student in response to receiving a request for the primary instructional material or content. This request for primary instructional material or content may originate from a user, such as a teacher or a student, at the computing device 102. The user may be required to supply identifying information to establish the rights and privileges of the user to access certain material or content, as further discussed below.

After causing the primary instructional material to be displayed at the student workstation 102 of each student, the process 400 causes the system to enable each student to interact with the displayed primary instructional material, such as by enabling the student to make inputs in response to the displayed primary instructional material (block 406). For example, the system enables the student to input responses to the displayed problems of the lesson at the student workstation.

As each student interacts with the primary instructional material, the process 400 causes the system to monitor student inputs made by that student at the student workstation in response to the displayed primary instructional material (block 408). The process 400 causes the system to collect student input data based on the inputs made by the student in response to the displayed primary content. The process 400 causes the system to update the student profile data for the student in response to the student input data.

As the student's inputs are being monitored, the process 400 causes the system to determine if a designated triggering event occurs at any of the student workstations 102, which triggers or initiates a downtime period or interval. For example, the designated triggering event may occur at one of the student workstations 102 when the system detects that: (i) a student has completed a lesson; (ii) a student has completed a designated portion of a lesson (e.g., a designated number of problems of the lesson); (iii) a student has completed a learning session; (iv) a student has completed a designated portion of a learning session; (v) a designated amount of time has elapsed (e.g., the lesson and/or learning session has timed out); or (vi) any other suitable event which triggers a period of student inactivity at the student workstation occurs. In certain embodiments, the designated triggering event which triggers a downtime interval for a student at one of the student workstation may be based at least in part on activities occurring at other student workstations, as further discussed below. For example, the designated triggering event occurs if the system detects that a first student at a first student workstation has completed a lesson, and the teacher is busy working with another student at another student workstation.

In response to detecting an occurrence of the designated triggering event at one of the student workstations, the process 400 causes the system to generate supplemental material to be displayed to the student at that student workstation based on the student profile data for that student (block 416). The process 400 causes the system to display the supplemental material on the display device of the student workstation during the downtime interval (block 418).

In one embodiment, the system automatically switches or moves to the supplemental content in response to the occurrence of the designated triggering event. In one embodiment, after the designated triggering event occurs, the student may initiate the change from primary instructional material to supplemental material, such as by activating a button. In one such embodiment, the student-activated button is actuatable only at certain times. For example, the button is only actuatable when the system detects that the triggering event has occurred (e.g., a lesson has been completed by the student). In embodiments employing a touch screen, a touch screen button for changing from primary instructional material to supplemental material only appears or is actuatable at those times in which the student may interchange the display material.

The system enables the student to interact with the displayed supplemental content until an event occurs which causes the downtime interval to end or be terminated. In one embodiment, the downtime interval ends when the system detects that the student has finished interacting with the supplemental material (e.g., the downtime activity has been completed). In another embodiment, the downtime interval ends when the system detects that the display of the primary instructional material has been resumed, such as upon a user request to resume the display of primary instructional material. For example, the downtime interval ends in response to a teacher input which calls up the previously displayed lesson or a new lesson at the student workstation. In other embodiments, the duration of the downtime interval for a student at one of the student workstations is based on activities or events which occur at the other student workstations, as further discussed below.

In one embodiment, the supplemental material displayed to a student during the downtime interval is generated or selected based on the student's prescription or the student's performance on previously displayed primary instructional material (e.g. the previous lesson completed by the student). The supplemental material may be related to the primary instructional content. For example, if the student is working on a math lesson including a set of math problems when the designated triggering event occurs, the system provides an additional set of math problems for the student to complete during the downtime interval. The supplemental material may include enjoyable content, such as a fun game or activity which is not necessarily educational or which is not necessarily related to the primary instructional material.

In one embodiment, the system generates the supplemental material to be provided to a student based on whether or not the student satisfies certain performance-based criteria in association with the primary instructional material. Examples of such performance-based criteria may include: (i) completing a lesson within a designated amount of time, (ii) completing a designated number of problems within a designated amount of time, (iii) demonstrating a designated level of mastery of a particular skill or set of skills; (iv) demonstrating a designated level of improvement at a particular skill or set of skills, (v) achieving a designated score on a lesson, (vi) providing a designated number of correct answers during a lesson, (vii) providing a designated number of consecutive correct answers during a lesson, (viii) any other suitable criteria or condition relating to the student's performance, or (ix) any combination of these. If the determination is made that the student satisfies the performance-based criteria, the system provides a first type of supplemental material to the student during the downtime interval. If the determination is made that the student does not satisfies the performance-based criteria, the system provides a different type of supplemental material to the student during the downtime interval.

For example, if the student scores 80% or better on a lesson, the system provides the student with a fun activity, such as a game, during the downtime interval. If the student does not get a score of 80% or better on the lesson, the system provides the student with additional practice problems. The additional problems provided to the student may cover the same skill that was covered in the lesson, thereby giving the student the opportunity to have more practice at mastering that skill.

The supplemental material may include a bonus round, which is provided as a reward for satisfying certain performance-based criteria. The bonus round may include a fun game or activity. Alternatively, the bonus round may include an educational activity, such as another lesson or problem set, which enables the student to earn one or more rewards. For example, the bonus round may include a set of educational problems, where the student has the opportunity to earn redeemable tokens for satisfying certain performance-based criteria in connection with the set of problems.

In one embodiment, the supplemental material selected and displayed to the student is based on the student completing the primary instructional material, such as a lesson, within a specified amount of time. For example, if the student completes a lesson within the specified amount of time, the system enables the student to play a game or participate in a bonus round during the downtime interval. If the student does not complete the lesson within a specified amount of time, the system provides an educational activity (e.g., additional problems) during the downtime interval.

In one embodiment, the system enables the student to choose the type of supplemental material that will be provided to the student during the downtime interval. For example, when the downtime interval is triggered, the system displays a list of supplemental material options to the student, and enables the student to select from the list of options. The student may be required to qualify for certain types of supplemental material (i.e., must earn the chance to do certain activities during downtime) based on the student's performance on the primary instructional material.

Thus, the disclosed system enables students to interact with selected supplemental material during downtime intervals, in a manner that accommodates student learning preferences and skill gaps and/or that rewards students for showing proficiency at a skill.

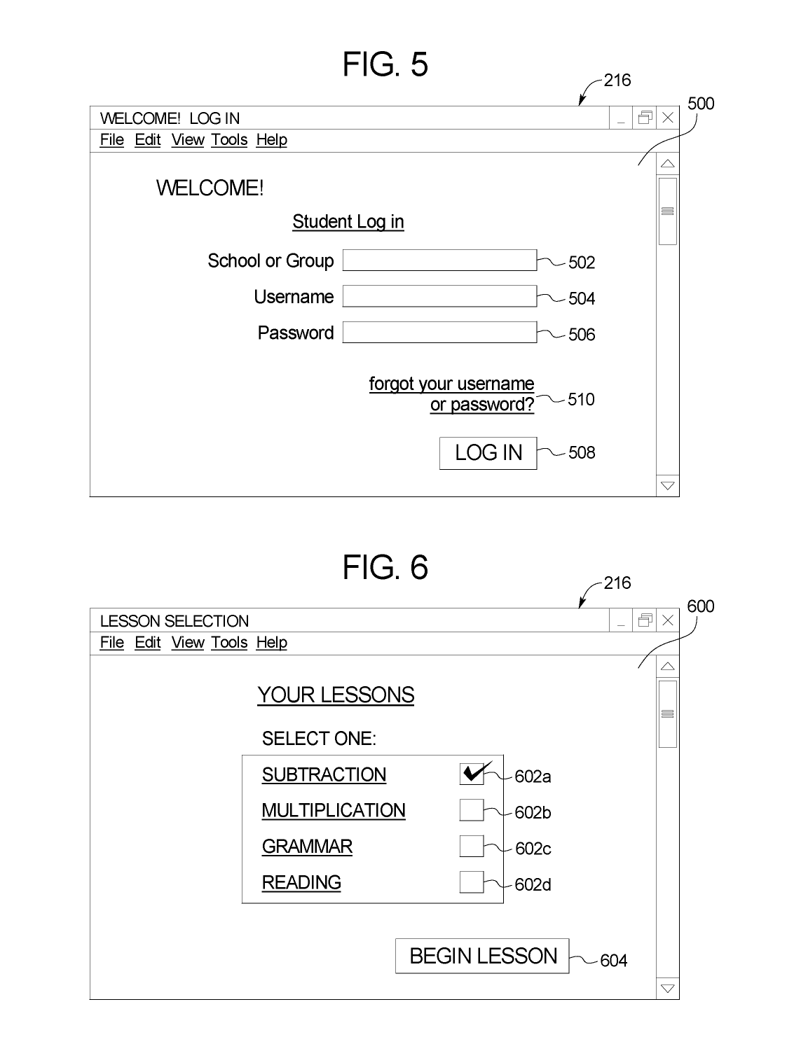

Referring now to FIGS. 5 to 15, in one example, the disclosed system is implemented in a learning environment where a teacher works with a plurality of students seated at a worktable, such as worktable 300 of FIG. 3A. Each student works at a computing device or student workstation 102 located on or supported by the worktable 300.

In the illustrated example, the student workstations 102 include tablet computers, each having a pen or stylus-based tablet input and display 216. Selected instructional materials or programs (e.g., lessons), may be provided to each student workstation 102 either by the network or run from a hard disk, RAM or other storage device on the tablet itself. A student workstation 102 is located in front of each student position, between that student position and the teacher position. Thus, each of the student workstations 102 has a student seated on one side of it and the teacher seated on the other side of it.

This configuration enables the teacher to work with each of the students in a face-to-face manner at various stages of a learning session. The teacher and the student can share and interact with the materials displayed on the display device 216 or screen of the student workstation 102. As discussed in detail below, the system determines which materials will be displayed in which orientation on the display device 216, such that information intended for each specific user is displayed to that user in a proper orientation on the display device.

FIG. 5 illustrates a close-up view of the display 216 of a first one of the student workstations 102. More particularly, FIG. 5 is a screen shot of an exemplary login screen 500 for a first student who is about to begin working on a lesson at the first student workstation 102. The login screen 500 may include a school or group text entry field 502 for the student to enter a school or group name or identification. A username text entry field 504 and password text entry field 506 may also be provided to enable the student to maintain privacy of their information. A soft-button 508 may be provided for the student to select for submission of the information in the text entry fields 502, 504, and 506. The system accepts the login information from the student and authenticates the student, such as by accessing a database to confirm that the user is a student as provided by a student profile.

FIG. 6 is a screen shot of an exemplary lesson selection screen 600 for the student. The lesson selection screen 600 may include a number of selectable options or boxes 602a, 602b, 602c, and 602d which each correspond to a lesson to be completed by the student. For example, as illustrated in FIG. 6, the selectable options or boxes 602a, 602b, 602c, and 602d include “Subtraction,” “Multiplication,” “Grammar,” and “Reading.” The student may select a lesson by selecting one of the boxes 602a, 602b, 602c, and 602d. A “Begin Lesson” soft-button 604 may be provided for the student to select or activate for submission of the lesson selection.

The system causes the student workstation 102 to enable the student to input lesson selections, responses to problems, or any other suitable command via one or more input devices. As described above, in the illustrated example, the student workstation 102 is a tablet computer having a touch-sensitive display device (e.g., a touch screen), configured to detect contact by a user's finger or a stylus. A user (e.g., a student or teacher) may have a stylus which is associated with or coded to that user. When a user utilizes his or her stylus to make inputs via the touchscreen, the computing device 102 associates any information or commands inputted with the owner of that stylus. It should be appreciated that other types of input devices, such as a mouse, trackball, a scroll wheel, a fingerprint reader, a touch pad, a sweep sensor, or the like may also be used with the tablet computer. One of more of these devices may be integrated with the tablet computer and/or exist separately.

The system may detect which user or users are using or interacting with the student workstation (or any of the other networked student workstations) at any given point in time based on the inputs being made at that workstation. For example, the system may determine that, a first point in time, a teacher is working at a first student workstation based on inputs made with the teacher's stylus at that first student workstation. If a student at a second student workstation completes a lesson at that same point in time, the system can detect that the teacher is not available to review the second student's work and will, therefore, cause supplemental material to be displayed to the second student at the second student workstation until the teacher becomes available.

Referring back to FIG. 6, the first student has selected the first box 602a, which corresponds to the Subtraction Lesson. In response to the submission of the first student's lesson selection, the student workstation 102 causes lesson content to be displayed to the first student on the display device 216 of the student workstation 102.

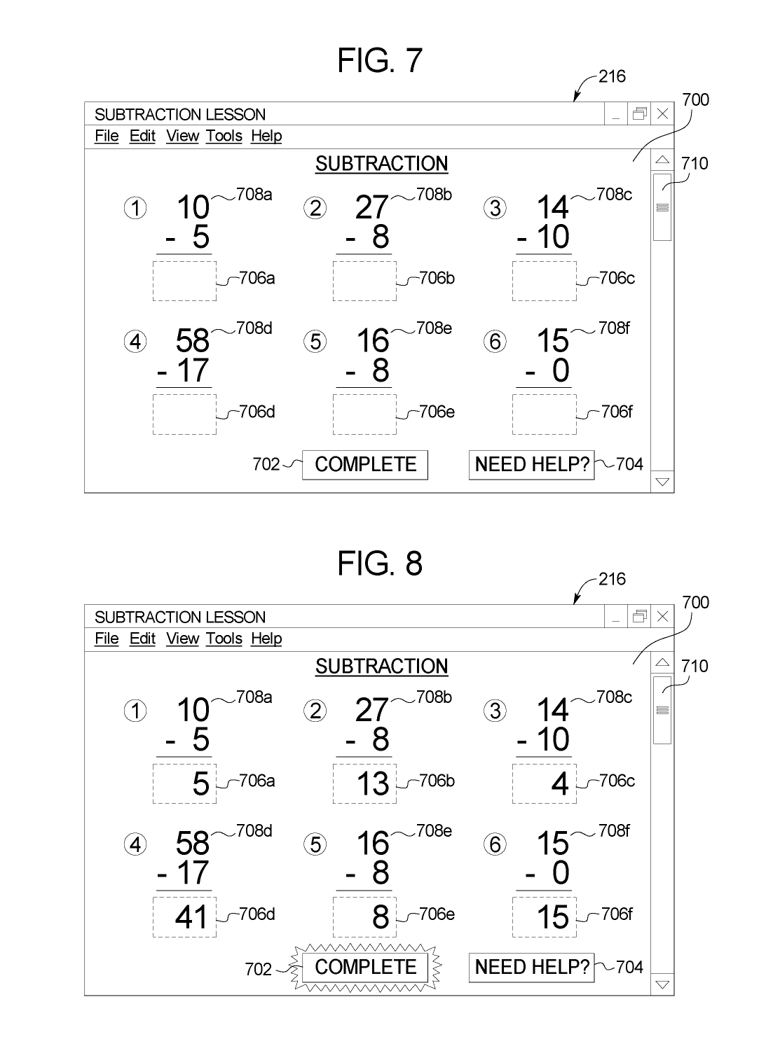

FIG. 7 is a screen shot of an exemplary lesson screen 700. The lesson screen 700 displays a set of subtraction problems. The screen also displays a vertical scroll bar 710 for scrolling up and down the problem set, if necessary. The set of subtraction problems includes six problems 708a, 708b, 708c, 708d, 708e, and 708f to be completed by the student. In the illustrated example, the first student answers the displayed subtraction problems by physically entering the answer on the lesson screen 700 in a respective answer area 706a, 706b, 706c, 706d, 706e, and 706f for each of the six problems 708a, 708b, 708c, 708d, 708e, and 708f. Using the stylus, the student solves the problems and inputs answers to those problems via the touch screen. The tablet computer interprets gestures and contacts made using stylus to manipulate data, enter text, and the like.

A “Complete” soft-button 702 may be provided for the student to select or activate for submission of his or her answers. That is, the student may activate a soft-button 702 labeled with the word “COMPLETE” when he or she has completed the lesson. Other suitable buttons, such as a “Need Help?” button 704 may be provided.

As illustrated in FIG. 8, the first student has written in an answer for each problem displayed on the lesson screen 700. More particularly, using a stylus, the first student has written in an answer for each problem in the answer area for that problem, as in a traditional written mathematics exercise. When the first student has completed the subtraction problems and it is time for the teacher to review the student's work, the first student activates the “COMPLETE” soft button 702.

In certain embodiments, completion of the lesson may be automatically detected by the system, without requiring a separate input by the student. For example, the system may automatically determine that the lesson has been completed when the student has inputted answers for a designated number (such as all) of the problems, or when a designated amount of time has elapsed, regardless of how many problems the student has answered.

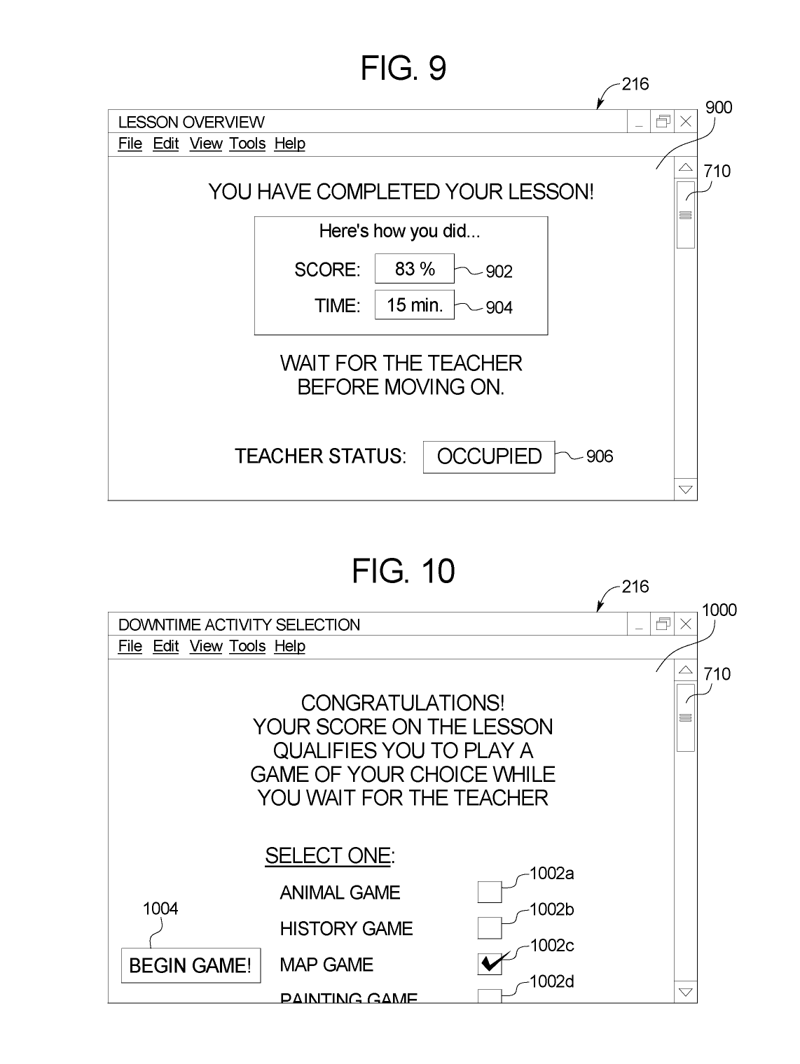

FIG. 9 is a screen shot of an exemplary lesson completion or lesson overview screen 900. The lesson overview screen 900 provides information relating to the lesson that has just been completed by the first student. In FIG. 9, the lesson overview screen 900 includes a lesson score field 902, which displays the first student's score for the lesson that has just been completed. The lesson overview screen 900 also includes a lesson time field 904, which displays the amount of time it took the first student to complete the lesson. The lesson overview screen 900 also includes a teacher status indicator 906, which provides information about the teacher's availability. As illustrated in FIG. 9, the teacher is currently occupied. The teacher may be assisting another student at another one of the student workstations. In various embodiments, the lesson overview screen 900 may provide an indication of the student's position in a queue of students who are waiting for the teacher to review their work. The student's position in the queue may be determined, for example, on how long it took for the student to complete the lesson in comparison to the other students at the other workstations, how the student performed on the lesson, or in any other suitable manner.

As illustrated in FIG. 9, the lesson score field 902 shows that the first student received a score of 83%, and the lesson time field 904 indicates that it took the first student 15 minutes to complete the lesson. The a teacher status indicator 906 shows that the teacher is not currently available (e.g., the teacher status indicator displays the word “OCCUPIED”). It should be appreciated that, at this stage in the student's learning session, the first student has completed a lesson, but the teacher is currently unavailable to review the student's work. As a result, a downtime interval has been triggered. In response to the triggering of the downtime interval, the system will generate supplemental content to be displayed to the first student during the downtime interval.

As described above, in certain embodiments, the supplemental material displayed to a student during the downtime interval is generated or selected based on the student's prescription or the student's performance on previously displayed primary instructional material (e.g. the previous lesson completed by the student). The supplemental material displayed to the student during the downtime interval may be based on whether or not the student satisfied certain performance criteria or conditions in association with the lesson, such as completing the lesson within a designated lesson completion time or obtaining a lesson score that is equal to or greater than a designated lesson score.

In the illustrated embodiment, the supplemental material selected and displayed to the student during downtime is based on the student achieving a certain score on the lesson immediately preceding the downtime trigger. More particularly, if the student scores 80% or better on a lesson, the system provides the student with a game or a bonus round to the student during the downtime. If the student does not get a score of 80% or better on the lesson, the system provides additional practice problems (e.g., additional problems covering the same skill that was covered in the lesson) during downtime instead of a game or bonus round.

As illustrated in FIG. 10, based on the first student's score of 83% on the lesson, the student qualifies to play a game during the downtime interval. In this example, the system enables the first student to choose which game he or she wants to play from a plurality of different games listed on a downtime activity selection screen, as discussed below.

FIG. 10 is a screen shot of an exemplary supplemental content selection screen 1000 for the first student. The supplemental content screen 1000 may include a number of selectable options or boxes 1002a, 1002b, 1002c, and 1002d which each correspond to a game that the first student can choose to play during the downtime interval. For example, as illustrated in FIG. 10, the selectable options or boxes 1002a, 1002b, 1002c, and 1002d include “Animal Game,” “History Game,” “Map Game,” and “Painting Game.” The first student may select a game for the downtime interval by selecting one of the boxes 1002a, 1002b, 1002c, and 1002d. A “Begin Game” soft-button 1004 may be provided for the student to select or activate for submission of the game selection. It should be appreciated that, in various alternative embodiments, the games may include educational games or fun games, where the types and/or number of games available to each student is based on the student's performance on the lesson.

As illustrated in FIG. 10, the first student has selected the Map Game. After the student selects the game, the system enables the first student to play the game as he or she waits for the teacher to become available.

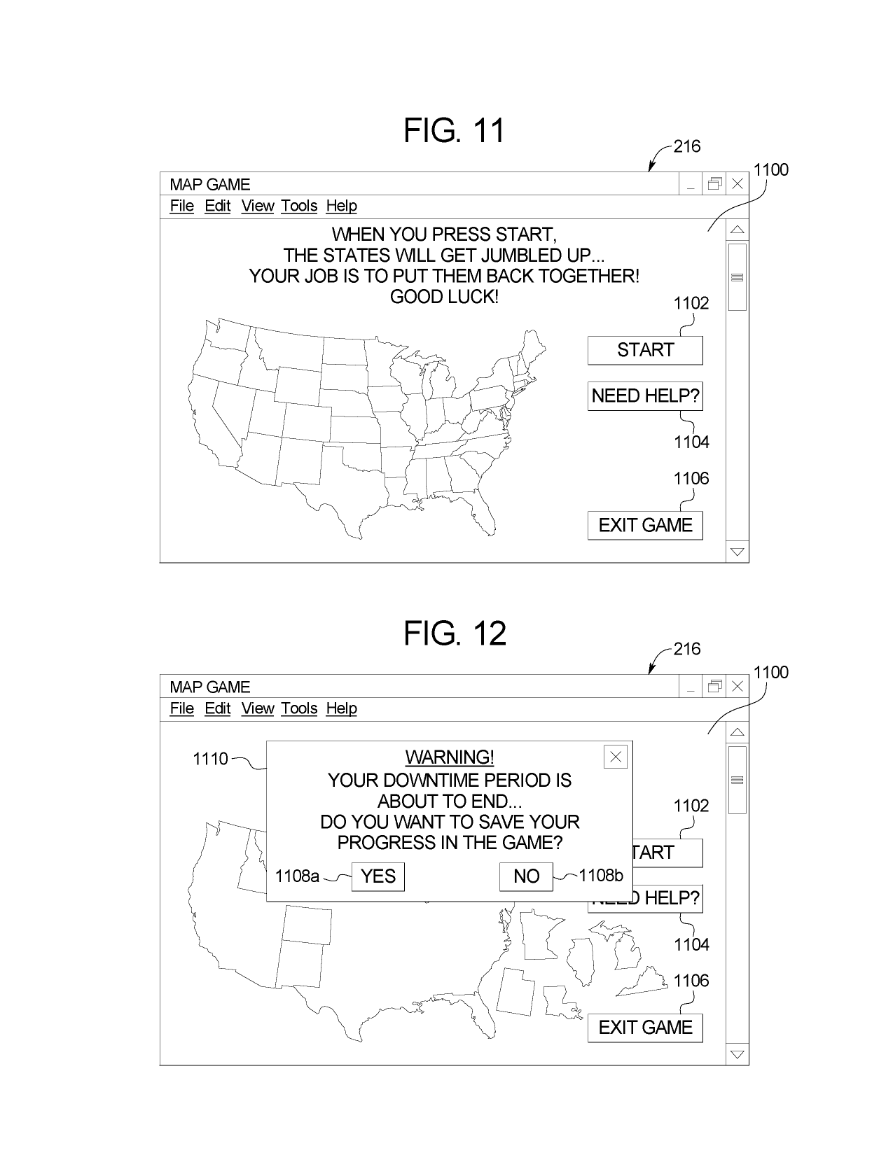

FIG. 11 is a screen shot of an exemplary game screen 1100 for the first student. The game screen displays the map game to the first student. In this example, the map game includes a puzzle-type game, where the states on the U.S. map become jumbled and the student must put them all back together. The system will continue to display and enable the first student to interact with the supplemental content (e.g., play the map game) until the determination is made that the teacher is available to review the first student's work.

In certain embodiments, the system may provide a warning to the student to alert the student that the downtime interval is about to end. For example, as illustrated in FIG. 12, a warning window 1110 has appeared on the screen, which indicates to the first student that the downtime interval is about to end. In the illustrated example, if a student has not completed interacting with student the supplemental material when the downtime interval ends (e.g., the student has not finished the game), the system enables the student to pause and/or save the supplemental material. The warning window 1110 may include a “pop-up” window (or a non-overlapping window). When the downtime interval terminates (or is about to terminate), the pop-up window appears and blocks a portion of the game screen or interface.

As illustrated in FIG. 12, the a warning window 1110 enables the first student to choose whether or not to save the game by activating the “Yes” button or the “No” button. If the first student chooses to save the supplemental material (by activating the “Yes” button), the first student will have the ability to access that supplemental material during a subsequently triggered downtime interval and pick up at the point at which the supplemental material was paused or saved. For example, the student can save his or her progress in a game and pick up where he or she left off in the game the next time a downtime interval is triggered. The system may require the student to achieve certain performance-based events in association with primary instructional material (e.g., a next lesson provided to the student) in order to re-access the saved game.

In one embodiment, the downtime interval for the first student ends automatically upon detecting that the teacher is available. This may occur, for example, when the system senses that the teacher has logged off from a session with another student at another one of the student workstations, or when the system senses that the teacher has not been making inputs at the other student workstation for a designated period of time, such as thirty seconds, one minute or five minutes. Alternatively, the downtime interval for the first student ends when the teacher makes an input at the first student's workstation. When the teacher is ready to begin reviewing the first student's work, the teacher may input a request at the first student's workstation to cause the primary instructional material (e.g., lesson) to be displayed once again on the display device of the student workstation. For example, the teacher may activate a button to cause the primary instructional material to re-appear on the display device.

As illustrated in FIG. 12, when the teacher is ready to begin reviewing the student's work on the previously displayed lesson, the teacher activates the “Exit Game” button 1106 of the game screen 1100. This causes the lesson previously completed by the first student to re-appear on the display device of the student workstation 102 in place of the supplemental material.

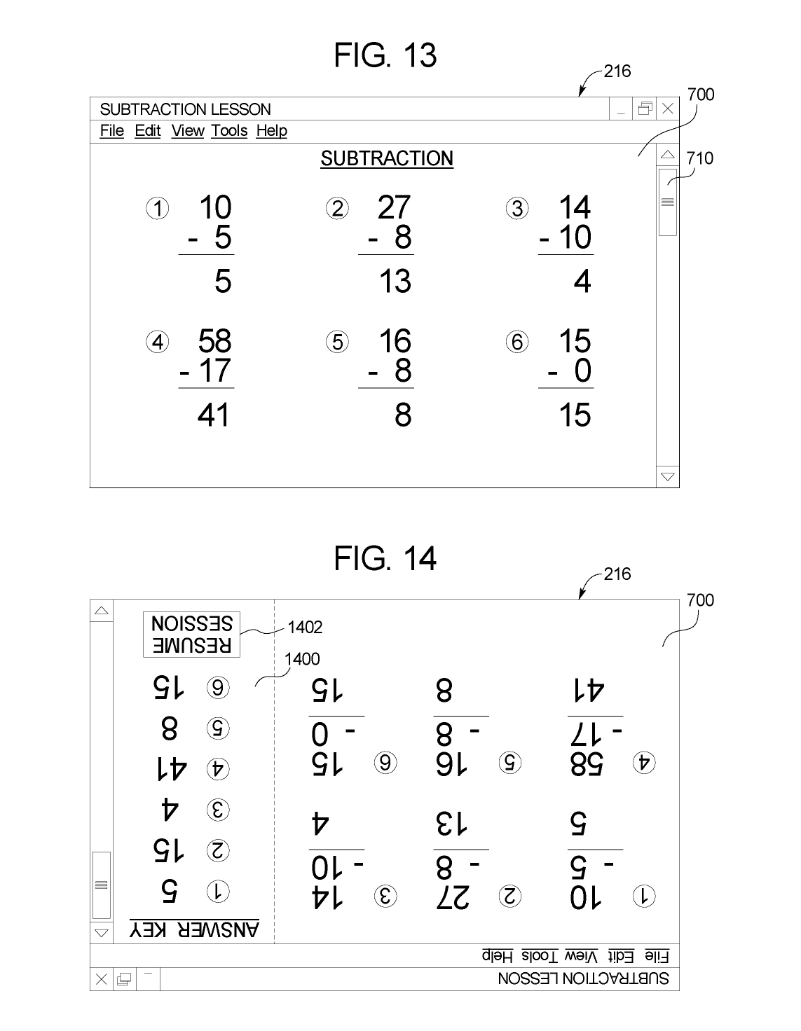

FIG. 13 illustrates that the lesson screen 700 has re-appeared on the display device of the first student's workstation. The subtraction problems of the lesson and the first student's answers to the problems are displayed on the lesson screen 700. It should be appreciated that, the lesson is displayed in an orientation which is appropriate for the first student. That is, the lesson is displayed in such a way that the first student can read the textual content displayed on the screen in a conventional left to right manner. When the teacher is working with the first student at the worktable 300, the teacher sits across from the first student, on the opposite side or end of the student workstation 102. Accordingly, the lesson screen 700, as shown in FIG. 13, is in a proper orientation relative to the first student, but appears inverted or up-side-down to the teacher.

The system enables causing the displayed material (e.g., the displayed lesson) to be re-oriented such that it is displayed in a proper orientation for which ever user wishes to view or interact with the material. For example, this may be accomplished by flipping the displayed material on the screen, rotating the displayed material on the screen, or splitting the screen, as further discussed below. The system may provide a re-orientation tool (not shown) for causing an adjustment or change in the orientation of the displayed material. Activating the re-orientation tool may cause the displayed material to flip or rotate from a first orientation to a second different orientation on the display device. For example, a teacher may activate the reorientation tool to cause the lesson to be displayed in an orientation which is appropriate for the teacher.

Activating the reorientation tool may include contacting a surface or soft button of the touch screen. Contacting the surface of the touch screen can be accomplished, for example, through use of a stylus or finger, as described above. It should be appreciated, however, that other input devices may be used. The activation of the reorientation tool may be accomplished in different ways. For example, a user can activate the reorientation tool by causing a pull-down menu to appear on the display. The reorientation of the displayed data can be accomplished by choosing a degree of reorientation, e.g., 180 degrees, from the pull-down menu.

As illustrated in FIG. 14, the displayed lesson has been caused to flip or rotate 180 degrees, such that it appears inverted or upside down relative to the first student. However, the lesson is now displayed in a correct orientation with respect to a teacher located on the opposite side of the first student's student workstation 102. That is, the lesson is displayed in such a way that the teacher can read the textual content displayed on the screen in a conventional left to right manner. The teacher can see the problems that were presented to the student as well as the first student's responses to the problems. Additionally, an answer key 1400 is displayed on the screen. The answer key 1400 includes the correct answers to the questions for comparison with the student's answers. The system may require the teacher to input a teacher identifier, such as a teacher identification code or PIN number, to flip or rotate the lesson and/or to access the answer key. The teacher identifier may include a teacher input made using a stylus that is coded for the teacher. It should be appreciated that, in the illustrated example, when the displayed material is flipped or rotated, the teacher can see all the information that was available to the first student (e.g., the problems and the student's answers), as well as the answer key, which was not displayed or made displayable to the first student.

Although not shown, in an alternative embodiment, rather than flipping or rotating the displayed material, the system may cause the display 216 to split or divide into two separate display regions in response to a user input, such that content appropriate for the student is displayed in the first orientation in the first display region and content appropriate for the teacher is displayed in the second orientation in the second different display region.

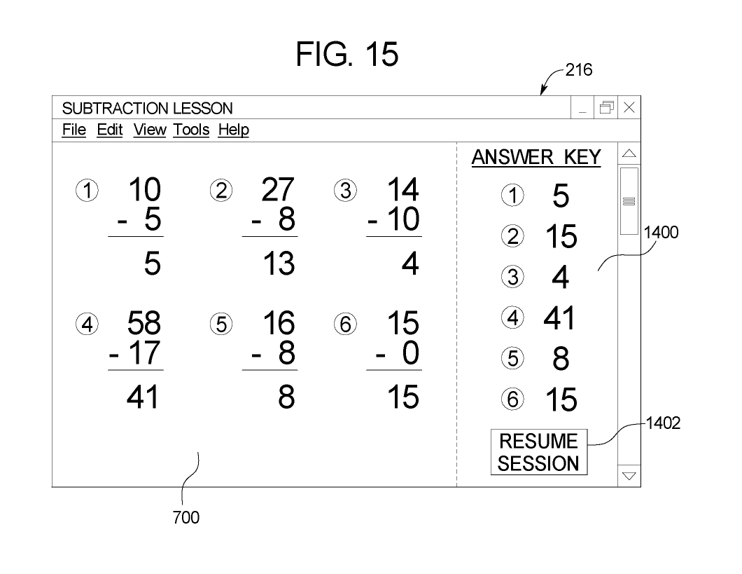

FIG. 15 shows the screen of FIG. 14 after the lesson has been flipped or rotated and from the perspective of the teacher. Just as in FIG. 14, the answer key 1100 is displayed on the screen adjacent to the problems and the first student's answers to the problems. The answers of the answer key 1100 may include text, graphics, video, or any other form of media to further assist the teacher in grading the first student's answers. For each of the problems of the lesson, the teacher compares the first student's answer to that problem with the correct answer, as provided in the answer key 1400. For each problem, the teacher determines whether the first student's answer matches the answer from the answer key 1100. The teacher can provide feedback to the first student based on the first students performance on the lesson.

It should be appreciated that, while the teacher is working with the first student to review the first student's work and provide feedback, as discussed above, there may be other students at other student workstations engaged in downtime activities. When the system detects that the teacher has finished working with the first student (such as based on a lack of teacher inputs at the first student's workstation for a designated period of time, or in response to the teacher logging off at the first student's workstation), this may trigger the end of the downtime interval for another one of the students.

The system may allow for “pop-up” windows (also, non-overlapping windows) that may be controlled by in certain locations in a time dependent manner. For instance, when a downtime interval is triggered at a student workstation (e.g., when the student completed a lesson), a pop-up window including the supplemental content appears and blocks a portion of the lesson screen or interface. The pop-up window for the supplemental content may be closed when the system detects an event that causes the downtime interval to end (e.g., an event which indicates that a new lesson is going to begin).

In one embodiment, the supplemental material includes content obtained by third-parties. In one embodiment, the supplemental content may include one or more interactive widgets, which change their appearance or function based on user input. The interactive widget may be displayed on the screen with a variety of shapes and may provide a variety of functions. For example, the interactive widget may enable a student to explore and discover the relationship between the radius, diameter, area and circumference of a circle. In one variation, the teacher or student may sketch a circle on a screen using a stylus, and the sketch turns into a perfect circle, which displays the circle's radius, diameter, area and circumference dynamically as it is resized. To resize the circle, the student may touch and drag a designated point along the circle's circumference, and the values for the circle's radius, diameter, area and adjust accordingly.

In one embodiment, the system enables students to create or author supplemental content during downtime intervals, rather than using stored or existing supplemental content. For example, the system may include one or more authoring tools that enable the students to create supplemental content which may be stored for later use by other students. These authoring tools could include photo editing tools, video editing tools, audio editing tools, software development tools, web site editing tools, or any other appropriate tools to enable creation of digital content.

For example, the system enables a student to create double digit addition problems and work through those problems during the downtime interval. The supplemental material created by the student may be scored or corrected by the computer or by the teacher. In one embodiment, the system automatically determines the answers to the supplemental material (e.g., problems) created by the student, such that a teacher can easily correct the work without re-working the problem.

The student-generated supplemental material may be stored and re-used throughout the system. For example, supplemental material generated by a first student may be stored and subsequently displayed to a second student when that student has downtime. Alternatively or additionally, student-generated supplemental material may be incorporated into instructional materials, which are provided to students during their learning sessions. Students may be rewarded, such as with redeemable tokens or other suitable awards or prizes, for creating supplemental material.

While the present invention has been illustrated by a number of preferred embodiments, one of ordinary skill in the art will recognize that deletions, additions, modifications and improvements can be made while remaining within the scope and spirit of the appended claims.

The invention is claimed as follows:

1. A method for managing student activities, said method comprising:
(a) generating primary instructional material to be displayed to a first student at a first student workstation;
(b) displaying the primary instructional material to the first student at the first student workstation; and
(c) in response to an occurrence of a triggering event at the first student workstation which initiates a downtime interval for said first student:
(i) enabling the first student to input supplemental material at the first student workstation during the downtime interval, said supplemental material including question data and answer data;
(ii) receiving the supplemental material input by the first student at the first student workstation during the downtime interval;
(iii) determining whether supplemental material input by the student is correct;
(iv) creating a supplemental material file from the received supplemental content; and
(iii) storing the supplemental material file for future display to a second different student at a second different student workstation.

2. The method of claim 1, which includes enabling the second different student to access the supplemental material file in response to an occurrence of the designated triggering event at the second student workstation which causes a downtime interval to initiate for said second different student.

3. The method of claim 1, wherein determining whether the supplemental material input by the student is correct includes performing an evaluation which includes a comparison of the answer data input by the first student and a correct answer associated with the question data.

4. The method of claim 3, wherein determining whether the supplemental material input by the student is correct includes automatically determining whether the supplemental material input by the student is correct.

5. The method of claim 3, wherein determining whether the supplemental material input by the student is correct includes receiving an indication of correctness of the answer data from a user.

6. The method of claim 5, wherein the user is a teacher.

7. The method of claim 1, wherein generating the primary instructional material to be displayed to the first student at the first student workstation includes generating the primary instructional material based on a student profile associated with the first student.

8. The method of claim 1, wherein the triggering event occurs in response to detecting that said primary instructional material is complete.

9. The method of claim 1, wherein the triggering event occurs when a designated amount of time has elapsed.

10. The method of claim 1, wherein the triggering event is based at least in part on an event which occurs at a student workstation which is different from the first student workstation.

11. The method of claim 1, which includes providing at least one electronic token to the first student after receiving said supplemental material.

12. The method of claim 11, which includes providing the at least one redeemable token to the first student if the determination is made that the received supplemental material is correct.

13. The method of claim 1, which includes storing the supplemental material file in a memory.

14. An apparatus for managing student activities, the apparatus comprising:
at least one processor;
at least one input device;
at least one display device; and
at least one memory device which stores a plurality of instructions, which when executed by the at least one processor, cause the at least one processor to operate with the display device and the input device to:
(a) generate primary instructional material to be displayed to a first student;
(b) display the primary instructional material to the first student; and
(c) in response to an occurrence of a triggering event which initiates a downtime interval for said first student:
(i) enable the first student to input supplemental material during the downtime interval, said supplemental material including question data and answer data;
(ii) receive the supplemental material input by the first student during the downtime interval;
(iii) determine whether supplemental material input by the student is correct;
(iv) create a supplemental material file from the received supplemental content; and
(iii) store the supplemental material file for future display to a second different student.

15. The apparatus of claim 14, wherein the plurality of instructions cause the processor to enable the second different student to access the supplemental material file in response to an occurrence of the designated triggering event which causes a downtime interval to initiate for said second different student.

16. The apparatus of claim 14, wherein the plurality of instructions cause the processor to determine whether the supplemental material input by the student is correct by performing an evaluation which includes a comparison of the answer data input by the first student and a correct answer associated with the question data.

17. The apparatus of claim 16, wherein the plurality of instructions cause the processor to automatically determine whether the supplemental material input by the student is correct.

18. The apparatus of claim 16, wherein the plurality of instructions cause the processor to determine whether the answer data input by the student is correct by receiving an indication of correctness of the answer data from a user.

19. The apparatus of claim 18, wherein the user is a teacher.

20. The apparatus of claim 14, wherein the plurality of instructions cause the processor to generate the primary instructional material to be displayed to the first student based on a student profile associated with the first student.

21. The apparatus of claim 14, wherein the triggering event occurs in response to detecting that said primary instructional material is complete.

22. The apparatus of claim 14, wherein the triggering event occurs when a designated amount of time has elapsed.

23. The apparatus of claim 14, wherein the triggering event is based at least in part on an event which occurs in association with a different student from said first student.

24. The apparatus of claim 14, wherein the plurality of instructions cause the processor to provide at least one electronic token to the first student after receiving said supplemental material.

25. The apparatus of claim 24, wherein the plurality of instructions cause the processor to provide the at least one redeemable token to the first student if the determination is made that the received supplemental material is correct.
